(19) United States
(12) Patent Application Publication
(10) Pub. No.: US 2015/0126680 A1
(43) Pub. Date: May 7, 2015

(54) PARTICLES FOR ELECTROPHORETIC DISPLAYS

(71) Applicant: Merck Patent GmbH, Darmstadt (DE)

(72) Inventors: Louise Diane Farrand, Dorset (GB); Jonathan Henry Wilson, Southampton (GB); Simon Biggs, Wetherby (GB); Olivier Cayre, Thurlstone (GB); Simon Lawson, Harrogate (GB); Alexandre Richez, Newport (GB); Simone Stuart-Cole, Morpeth (GB)

(73) Assignee: Merck Patent GmbH, Darmstadt (DE)

(21) Appl. No.: 14/400,617

(22) PCT Filed: May 7, 2013
(86) PCT No.: PCT/EP2013/001335

§ 371 Date: Nov. 12, 2014

(30) Foreign Application Priority Data
May 14, 2012 (EP) 12003782.5

(51) Int. Cl. C08F 292/00; G02F 1/00; G02F 1/167

(52) U.S. Cl. CPC C08F 292/00; G02F 1/167; G02F 1/0009; G02F 2001/1678
USPC 524/849

(57) ABSTRACT

This invention relates to particles comprising a core particle and a polymeric shell, a process for their preparation, electrophoretic fluids comprising such particles, and electrophoretic display devices comprising such fluids.

This invention relates to particles comprising a core particle and a polymeric shell, a process for their preparation, electrophoretic fluids comprising such particles, electrophoretic display devices comprising such fluids, and the use of the particles in optical, electrooptical, electronic, electrochemical, electrophotographic, electrowetting and electrophoretic displays and/or devices, in security, cosmetic, decorative or diagnostic applications.

EPDs (Electrophoretic Displays) and their use for electronic paper are known for a number of years. An EPD generally comprises charged electrophoretic particles dispersed between two substrates, each comprising one or more electrodes. The space between the electrodes is filled with a dispersion medium which is a different colour from the colour of the particles. If a voltage is applied between the electrodes, charged particles move to the electrode of opposite polarity. The particles can cover the observer's side electrode, so that a colour identical to the colour of the particles is displayed when an image is observed from the observer's side. Any image can be observed using a multiplicity of pixels. Mainly black and white particles are used. Particles coated with a surface layer to promote good dispersibility in dielectric media are disclosed in WO 2004/067593, US 2011/0079756, U.S. Pat. No. 5,964,935, U.S. Pat. No. 5,932,633, U.S. Pat. No. 6,117,368, WO 2010/148061, WO 2002/093246, WO 2005/036129, US 2009/0201569, U.S. Pat. No. 7,236,290, JP 2009031329, U.S. Pat. No. 7,880,955, and JP 2008122468.

There continues to be a demand for improved electrophoretic fluids and a simple preparation of coloured and white reflective particles which can be easily dispersed in non-polar media. An improved route to provide such particles and new electrophoretic fluids has now been found. Fluid compositions containing these particles can be used in monochrome and colour electrophoretic displays (EPD).

The present invention relates to particles comprising organic or inorganic pigment core particles encapsulated by a polymeric shell comprising monomer units of at least one polymerisable steric stabiliser, at least one co-monomer, optionally at least one charged co-monomer, optionally at least one polymerisable dye, and optionally at least one crosslinking co-monomer and wherein the polymeric shell is linked to the surface of the organic or inorganic pigment core particles by at least one reagent for controlled radical polymerisation, a process for their preparation, the use of the particles in electrophoretic fluids, and electrophoretic display devices comprising these fluids. The subject matter of this invention specifically relates to white reflective particles, and to electrophoretic fluids and displays comprising such white reflective particles.

The invention provides a method to produce particles suitable for use in EPD which have controllable size, reflectivity, density, monodispersity, and steric stability and require no drying process to disperse in a solvent suitable for EPD. The particles are synthesized in a method which has surface stabilisation of the pigment core particles, i.e. white reflective component which improves synthesis for a number of reasons. The white reflective components are often inorganic and as such they are difficult to disperse in organic media. Surface treatment before polymerisation facilitates dispersion, separating individual particles resulting in a more homogeneous polymerisation and facilitating covalent linkage of the polymeric coating to the surface of the pigment.

The present invention provides pigment particles, especially white reflective particles which can be easily dispersed in non-polar media and show electrophoretic mobility. Particle size, polydispersity, and density can be controlled and the present incorporation of pigment into polymeric particles does neither require multiple process steps nor expensive drying steps, i.e. freeze drying. The present process involves one simple surface modification step and one polymerisation step. The present process facilitates the formulation of electrophoretic fluids since it is done in a non-polar organic solvent instead of aqueous media. The particles can be prepared in the solvent of choice for EPD formulations, therefore no unwanted solvent contamination occurs and no disposal, or recycling of solvent is necessary. Particles of the invention are easily dispersed in dielectric, organic media, which enables switching of the particles in an applied electric field, preferably as the electrically switchable component of a full colour e-paper or electrophoretic display.

Highly reflective polymer particles can be produced by encapsulating a highly reflective inorganic particle in an organic polymer by a dispersion polymerisation. This yields a hybrid particle which exhibits excellent reflectivity where the inorganic material is encapsulated by a tough polymer shell. This tough shell prevents particle agglomeration.

Particles of the invention comprise sterical stabilisers covalently bonded into the pigment core particles. Advantageously, the present invention does not require custom synthesised stabilisers with difficult to control steric lengths and multistep complex syntheses with expensive or difficult to synthesise components.

The present invention has a further advantage that the pigment core particle, i.e. titania is located near the centre of particles. The particles of the invention have titania dispersed throughout the polymer particle species as a result of the surface treatment before polymerisation and titania tends not to stick together as readily when compared to untreated titania samples. In particles not comprising the surface modification essential for the present invention, titania was found to be aggregated largely and this will naturally result in lower reflectivity.

According to the invention, surface modification is used to allow titania particles to be encapsulated by the polymer. This also results in titania being located towards the centre of the particles which should give better optics and more consistent electrophoretic behaviour.

Therefore, a further aspect of the invention is that it advantageously provides particles where the titanium dioxide is located towards the middle of the particles and not near the surface of the particle.

In addition, the particles may have a homogeneous cross-linked network structure for solvent resistance, impact strength and hardness, high electrophoretic mobility in dielectric media, excellent switching behavior, and faster response times at comparable voltages.

The core particles can be selected to achieve different optical effects. Properties can vary from being highly scattering to being transparent. The pigments can be coloured including black or white.

Primarily, the invention provides white reflective particles by incorporating an inorganic material of sufficiently high refractive index and white reflectivity into an organic polymer based particle to yield a hybrid polymeric particle which exhibits good white reflective properties. Preferably, white reflective particles are used having a refractive index of ≧1.8, especially ≧2.0, are used.

Especially titanium dioxide, zinc oxide, silicon dioxide, alumina, barium sulphate, zirconium dioxide, calcium carbonate, cerussite, kaolinite, diantimony trioxide and/or tin dioxide, especially titanium dioxide, can be used.

Preferably, titanium dioxide based pigments are used which could have the rutile, anatase, or amorphous modification, preferably rutile or anatase. Examples are: Sachtleben RDI-S, Sachtleben R610-L, Sachtleben LC-S, Kronos 2081, Kronos 2305, Sachtleben Hombitan Anatase, Sachtleben Hombitan Rutile, Du Pont R960, Du Pont R350, Du Pont R104, Du Pont R105, Du Pont R794, Du Pont R900, Du Pont R931, Du Pont R706, Du Pont R902+, Du Pont R103, Huntsman TR-81, Huntsman TR-28, Huntsman TR-92, Huntsman R-TC30, Huntsman R-FC5, Evonik P25, Evonik T805, Merck Eusolex T2000, Merck UV Titan M765. Preferably, Du Pont R960 is used. Examples of pigments suitable to achieve colour or black are: carbon black, chromium (Ill) oxide green, cobalt blue spinel, iron (III) oxide red, iron (III) oxide orange, iron oxide hydroxide (FeOOH) yellow, iron oxide (Fe₃O₄) black, iron (II, III) oxide black.

The invention allows density control by tunability of the shell around the inorganic pigment. The amount of the organic material in the reaction can be increased relative to the inorganic pigment which results in a lower density particle, or if higher density is desired, the pigment ratio can be increased.

Pigments encapsulated within the particles are preferably well dispersed in a non-aggregated state in order to achieve the optimum optical properties. If the pigment is high density, the optimum loading of the pigment within polymer may not only be affected by the optical properties but also the density of the resulting particle in order to achieve improved bistability. Pigments are present in the particle (on weight of total particle) from 5-95%, preferably 20-60% and even more preferably 30-50%.

A further essential component of the present invention is a polymerisable steric stabiliser. The polymerisable steric stabilisers need to be soluble in non-polar solvents, particularly dodecane, and have some reactive functionality such that they take part in the polymerisation. This creates a particle with a covalently bound surface of sterically stabilising compounds providing stability during and after polymerisation. The polymerisable steric stabiliser can be used in a range of molecular weights which allows strict control over the steric barrier surrounding the particles to prevent aggregation. The polymerisable group incorporates irreversibly into the particles and is therefore anchored to the surface.

A typical polymerisable steric stabiliser of the invention is a poly(dimethylsiloxane) macro-monomer (PDMS). The poly(dimethylsiloxane) may comprise one or two polymerisable groups, preferably one polymerisable group.

The following stabiliser types could be used and are commercially available from Gelest Inc.:

Methacryloyloxypropyl terminated polydimethylsiloxanes (mws 380, 900, 4500, 10000, 25000) Methacryloyloxypropyl terminated polydimethylsiloxanes (mw 600), Methacryloyloxypropyl terminated polydimethylsiloxanes (1500, 1700), (3-acryloxy-2-hydroxypropoxypropyl) terminated PDMS (mw 600), Acryloxy terminated ethyleneoxide-dimethylsiloxane-ethyleneoxide ABA block copolymers (mw 1500, 1700), methacyloyloxpropyl terminated branched polydimethylsiloxanes (683), (methacryloxypropyl)methylsiloxanes—Dimethylsiloxane copolymers (viscosity 8000, 1000, 2000), (acryloxypropyl)methylsiloxane—dimethylsiloxanes copolymers (viscosity 80, 50), (3-acryloxy-2-hydroxypropoxypropyl)methylsiloxane-dimethylsiloxane copolymers (mw 7500), mono(2,3-epoxy)propyl ether terminated polydimethylsilxoanes (mw 1000, 5000), monomethacryloxypropyl terminated polydimethylsiloxanes asymmetric (mw 600, 800, 5000, 10000), monomethacryloxypropyl functional polydimethylsiloxanes-symmetric (mw 800), monomethacryloxypropyl terminated polytrifluoropropylmethylsiloxanes—symmetric (mw 800) monovinyl terminated polydimethylsiloxanes (mw 5500, 55000, monovinyl functional polydimethylsilxanes—symmetric (mw 1200).

Preferred polymerisable groups are methacrylate, acrylate, and vinyl groups, preferably methacrylate and acrylate groups. Most preferred are poly(dimethylsiloxane) methacrylates (PDMS-MA), especially methacryloyloxypropyl terminated PDMS-MAs as shown in Formulas 1 and 2, wherein n=5-10000. Most preferred are polydimethylsiloxanes) with one methacrylate group.

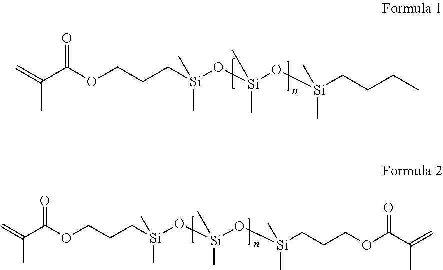

The polymerisable steric stabiliser of the invention preferably has a molecular weight in the range of 1000-50000, preferably 3500-35000, most preferably 5000-25000. Most preferred are methacrylate terminated polydimethylsiloxanes with a molecular weight of 10,000 or more.

Additionally, the present invention uses a special surface modifying agent for linking the polymeric shell to the surface of the organic or inorganic pigment core particles.

The surface modifying agent requires suitable reactivity to the particle surface and towards a growing polymer chain. The modifying agent must also contain such organic functionality that provides more easily dispersible inorganic particles for the organic medium for polymerisation.

Generally, reagents for controlled radical polymerisation such as ATRP (atom transfer radical polymerisation), NMP (nitroxide-mediated polymerisation) or RAFT (reversible addition fragmentation transfer polymerisation) could be used. However, most suitable for the present invention are reagents for RAFT polymerisation. RAFT polymerisation, RAFT agents, and the synthesis of RAFT agents are well known to the skilled person.

Preferably, trithio and dithiocarbonates with functionality for reaction to the pigment particle surface are used for the particles of the invention. Although carbamates and xanthates can also be used, most preferably, carboxylic acid functional RAFT agents are used, preferably the following:

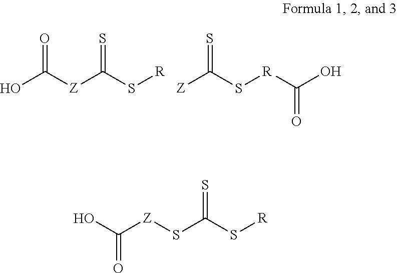

Wherein Z is selected from the group consisting of optionally substituted alkyl, optionally substituted aryl, optionally substituted heterocyclyl, optionally substituted alkylthio, optionally substituted alkoxycarbonyl, optionally substituted, aryloxy carbonyl (—COOR″), carboxy (—COOH), optionally substituted acyloxy (—O₂CR″), optionally substituted carbamoyl (—CONR″₂), dialkyl- or diaryl-phosphonato [—P(═O)OR″₂], diakyl- or diaryl-phosphinato [—P(═O)R″₂] or a polymer formed by any mechanism, R is selected from the group consisting of optionally substituted alkyl, an optionally substituted saturated, unsaturated or aromatic carbocyclic or heterocyclic ring, optionally substituted alkylthio, optionally substituted alkoxy, optionally substituted dialkylamino, an organometallic species and a polymer chain prepared by any method, R″ is selected from the group consisting of optionally substituted C₁-C18 alkyl, C2-C18 alkenyl, aryl, heterocyclyl, aralkyl, alkaryl wherein the substituents are independently selected from the group that consists of epoxy, hydroxyl, alkoxy, acyl, acyloxy, carboxy (and salts), sulfonic acids (and salts), alkoxy- or aryloxy-carbonyl, isocyanato, cyano, silyl, halo and dialkylamino.

Especially, 4-((thiobenzoyl)sulfanyl)-4-cyano-pentanoic acid or 3-((thiododecanoyl)sulfanyl)-3-methyl-propanoic acid are used:

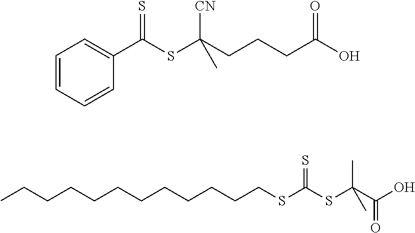 [SMILES: CC(C#N)(CCCC(=O)O)SC(=S)c1ccccc1 ; CCCCCCCCCCCCSC(=S)SC(C)(C)C(=O)O]

Further examples of reagents possible to be used can be found in J. Pol. Sci. Pt. A: Polymer Chemistry, Vol 49, 551-595 (2011) DOI: 10.1002/pola.24482 and are exemplified in patents WO1998001478, WO1999005099 and WO1999031144.

The particles of the invention can be prepared from many polymer types. Preferably, monomers are used where the monomer is soluble in the reactive mixture and the polymer is insoluble in the reactive mixture with relatively high Tg. This allows hard composite particles to be formed which tend to be spherical in shape and have easily tunable size.

The main requirement for the polymer composition is that it needs to be produced from a monomer that is soluble but polymer insoluble in the EPD fluid, i.e. dodecane and can also provide some linkage to the surface of the titania during polymerisation. Low solubility of the polymer material in the EPD dispersion media reduces the tendency for ripening processes to take place and helps define the particle size and size dispersity.

The particles can be prepared from most monomer types, in particular methacrylates, acrylates, methacrylamides, acrylonitriles, α-substituted acrylates, styrenes and vinyl ethers, vinyl esters, propenyl ethers, oxetanes and epoxys but would typically be prepared from largest percentage to be monomer, then cross-linker, and include a charged monomer (e.g. quaternised monomer). Especially preferred is methyl methacrylate but many others could be used, the following are all examples of which could be used which are commercially available from the Sigma-Aldrich chemical company.

The following are all examples which could be used and which are commercially available from the Sigma-Aldrich chemical company. Mixtures of monomers may also be used.

Methacrylates:

Methyl methacrylate (MMA), Ethyl methacrylate (EMA), n-Butyl methacrylate (BMA), 2-Aminoethyl methacrylate hydrochloride, Allyl methacrylate, Benzyl methacrylate, 2-Butoxyethyl methacrylate, 2-(tert-Butylamino)ethyl methacrylate, Butyl methacrylate, tert-Butyl methacrylate, Caprolactone 2-(methacryloyloxy)ethyl ester, 3-Chloro-2-hydroxypropyl methacrylate, Cyclohexyl methacrylate, 2-(Diethylamino)ethyl methacrylate, Di(ethylene glycol) methyl ether methacrylate, 2-(Dimethylamino)ethyl methacrylate, 2-Ethoxyethyl methacrylate, Ethylene glycol dicyclopentenyl ether methacrylate, Ethylene glycol methyl ether methacrylate, Ethylene glycol phenyl ether methacrylate, 2-Ethylhexyl methacrylate, Furfuryl methacrylate, Glycidyl methacrylate, Glycosyloxyethyl methacrylate, Hexyl methacrylate, Hydroxybutyl methacrylate, 2-Hydroxyethyl methacrylate, 2-Hydroxyethyl methacrylate, Hydroxypropyl methacrylate Mixture of hydroxypropyl and hydroxyisopropyl methacrylates, 2-Hydroxypropyl 2-(methacryloyloxy)ethyl phthalate, Isobornyl methacrylate, Isobutyl methacrylate, 2-Isocyanatoethyl methacrylate, Isodecyl methacrylate, Lauryl methacrylate, Methacryloyl chloride, Methacrylic acid, 2-(Methylthio)ethyl methacrylate, mono-2-(Methacryloyloxy)ethyl maleate, mono-2-(Methacryloyloxy)ethyl succinate, Pentabromophenyl methacrylate, Phenyl methacrylate, Phosphoric acid 2-hydroxyethyl methacrylate ester, Stearyl methacrylate, 3-Sulfopropyl methacrylate potassium salt, Tetrahydrofurfuryl methacrylate, 3-(Trichlorosilyl)propyl methacrylate, Tridecyl methacrylate, 3-(Trimethoxysilyl)propyl methacrylate, 3,3,5-Trimethylcyclohexyl methacrylate, Trimethylsilyl methacrylate, Vinyl methacrylate. Preferably Methyl methacrylate (MMA), Methacrylic acid, Ethyl methacrylate (EMA), and/or n-Butyl methacrylate (BMA) are used.

Acrylates:

Acrylic acid, 4-Acryloylmorpholine, [2-(Acryloyloxy)ethyl]trimethylammonium chloride, 2-(4-Benzoyl-3-hydroxyphenoxy)ethyl acrylate, Benzyl 2-propylacrylate, 2-Butoxyethyl acrylate, Butyl acrylate, tert-Butyl acrylate, 2-[(Butylamino)carbonyl]oxy]ethyl acrylate, Pert-Butyl 2-bromoacrylate, 4-tert-Butylcyclohexyl acrylate, 2-Carboxyethyl acrylate, 2-Carboxyethyl acrylate oligomers anhydrous, 2-(Diethylamino)ethyl acrylate, i(ethylene glycol) ethyl ether acrylate technical grade, Di(ethylene glycol) 2-ethylhexyl ether acrylate, 2-(Dimethylamino)ethyl acrylate, 3-(Dimethylamino)propyl acrylate, Dipentaerythritol penta-/hexa-acrylate, 2-Ethoxyethyl acrylate, Ethyl acrylate, 2-Ethylacryloyl chloride, Ethyl 2-(bromomethyl)acrylate, Ethyl cis-(β-cyano)acrylate, Ethylene glycol dicyclopentenyl ether acrylate, Ethylene glycol methyl ether acrylate, Ethylene glycol phenyl ether acrylate, Ethyl 2-ethylacrylate, 2-Ethylhexyl acrylate, Ethyl 2-propylacrylate, Ethyl 2-(trimethylsilylmethyl)acrylate, Hexyl acrylate, 4-Hydroxybutyl acrylate, 2-Hydroxyethyl acrylate, 2-Hydroxy-3-phenoxypropyl acrylate, Hydroxypropyl acrylate, Isobornyl acrylate, Isobutyl acrylate, Isodecyl acrylate, Isooctyl acrylate, Lauryl acrylate, Methyl 2-acetamidoacrylate, Methyl acrylate, Methyl α-bromoacrylate, Methyl 2-(bromomethyl)acrylate, Methyl 3-hydroxy-2-methylenebutyrate, Octadecyl acrylate, Pentabromobenzyl acrylate, Pentabromophenyl acrylate, Poly(ethylene glycol) methyl ether acrylate, Poly(propylene glycol) acrylate, Poly(propylene glycol) methyl ether acrylate Soybean oil, epoxidised acrylate, 3-Sulfopropyl acrylate potassium salt, Tetrahydrofurfuryl acrylate, 3-(Trimethoxysilyl)propyl acrylate, 3,5,5-Trimethylhexyl acrylate.

Preferably Methyl acrylate, acrylic acid, Ethyl acrylate (EMA), and/or n-Butyl acrylate (BMA) are used.

Acrylamides:

2-Acrylamidoglycolic acid, 2-Acrylamido-2-methyl-1-propanesulfonic acid, 2-Acrylamido-2-methyl-1-propanesulfonic acid sodium salt solution, (3-Acrylamidopropyl)trimethylammonium chloride solution, 3-Acryloylamino-1-propanol solution purum, N-(Butoxymethyl)acrylamide, N-tert-Butylacrylamide, Diacetone acrylamide, N,N-Dimethylacrylamide, N-[3-(Dimethylamino)propyl]methacrylamide, N-Hydroxyethyl acrylamide, N-(Hydroxymethyl)acrylamide, N-(Isobutoxymethyl)acrylamide, N-Isopropylacrylamide, N-Isopropylmethacrylamide, Methacrylamide, N-Phenylacrylamide, N-[Tris(hydroxymethyl)methyl]acrylamide,

Styrenes

Styrene, Divinyl benzene, 4-Acetoxystyrene, 4-Benzyloxy-3-methoxystyrene, 2-Bromostyrene, 3-Bromostyrene, 4-Bromostyrene, α-Bromostyrene, 4-tert-Butoxystyrene, 4-tert-Butylstyrene, 4-Chloro-α-methylstyrene, 2-Chlorostyrene, 3-Chlorostyrene, 4-Chlorostyrene, 2,6-Dichiorostyrene, 2,6-Difluorostyrene, 1,3-Diisopropenylbenzene, 3,4-Dimethoxystyrene, α,2-Dimethylstyrene, 2,4-Dimethylstyrene, 2,5-Dimethylstyrene, N,N-Dimethylvinylbenzylamine, 2,4-Diphenyl-4-methyl-1-pentene, 4-Ethoxystyrene, 2-Fluorostyrene, 3-Fluorostyrene, 4-Fluorostyrene, 2-Isopropenylaniline, 3-Isopropenyl-α,α-dimethylbenzyl isocyanate, Methylstyrene, α-Methylstyrene, 3-Methylstyrene, 4-Methylstyrene, 3-Nitrostyrene, 2,3,4,5,6-Pentafluorostyrene, 2-(Trifluoromethyl)styrene, 3-(Trifluoromethyl)styrene, 4-(Trifluoromethyl)styrene, 2,4,6-Trimethylstyrene. Preferably Styrene and/or Divinyl benzene are used.

Vinyl Groups

3-Vinylaniline, 4-Vinylaniline, 4-Vinylanisole, 9-Vinylanthracene, 3-Vinylbenzoic acid, 4-Vinylbenzoic acid, Vinylbenzyl chloride, 4-Vinylbenzyl chloride, (Vinylbenzyl)trimethylammonium chloride, 4-Vinylbiphenyl, 2-Vinylnaphthalene, 2-Vinylnaphthalene, Vinyl acetate, Vinyl benzoate, Vinyl 4-tert-butylbenzoate, Vinyl chloroformate, Vinyl chloroformate, Vinyl cinnamate, Vinyl decanoate, Vinyl neodecanoate, Vinyl neononanoate, Vinyl pivalate, Vinyl propionate, Vinyl stearate, Vinyl trifluoroacetate,

Other monomers which may be used are those which have groups to help stabilisation of the particles, e.g. Poly(ethylene glycol) methyl ether acrylate, Poly(ethylene glycol) phenyl ether acrylate, lauryl methacrylate, Poly(ethylene glycol) methyl ether acrylate, Poly(propylene glycol) methyl ether acrylate, Lauryl acrylate and fluorinated monomers of above.

Some of the monomers have groups for further reaction if so desired, e.g. Glycidyl ethacrylate, 2-Hydroxyethyl methacrylate.

The following compounds can be used as intraparticle crosslinking monomers for solubility control and solvent swelling resistance: ethylene glycol dimethacrylate (EGDMA), allyl methacrylate (ALMA), divinyl benzene, Bis[4-(vinyloxy)butyl] adipate, Bis[4-(vinyloxy)butyl] 1,6-hexanediylbiscarbamate, Bis[4-(vinyloxy)butyl]isophthalate, Bis[4-(vinyloxy)butyl] (methylenedi-4,1-phenylene)biscarbamate, Bis[4-(vinyloxy)butyl] succinate, Bis[4-(vinyloxy)butyl]terephthalate, Bis[4-(vinyloxymethyl)cyclohexylmethyl] glutarate, 1,4-Butanediol divinyl ether, 1,4-Butanediol vinyl ether, Butyl vinyl ether, tert-Butyl vinyl ether, 2-Chloroethyl vinyl ether, 1,4-Cyclohexanedimethanol divinyl ether, 1,4-Cyclohexanedimethanol vinyl ether, Di(ethylene glycol) divinyl ether, Di(ethylene glycol) vinyl ether, Ethylene glycol butyl vinyl ether, Ethylene glycol vinyl ether, Tris[4-(vinyloxy)butyl]trimellitate, 3-(Acryloyloxy)-2-hydroxypropyl methacrylate, Bis[2-(methacryloyloxy)ethyl]phosphate, Bisphenol A propoxylate diacrylate, 1,3-Butanediol diacrylate, 1,4-Butanediol diacrylate, 1,3-Butanediol dimethacrylate, 1,4-Butanediol dimethacrylate, N,N′-(1,2-Dihydroxyethylene)bisacrylamide, Di(trimethylolpropane) tetraacrylate, Diurethane dimethacrylate, N,N′-Ethylenebis(acrylamide), Glycerol 1,3-diglycerolate, Glycerol dimethacrylate, 1,6-Hexanediol diacrylate, 1,6-Hexanediol dimethacrylate, 1,6-Hexanediylbis[oxy(2-hydroxy-3,1-propanediyl)] bisacrylate, Hydroxypivalyl hydroxypivalate bis[6-(acryloyloxy)hexanoate], Neopentyl glycol diacrylate, Pentaerythritol diacrylate, Pentaerythritol tetraacrylate, Pentaerythritol triacrylate, Poly(propylene glycol) diacrylate, Poly(propylene glycol) dimethacrylate, 1,3,5-Triacryloylhexahydro-1,3,5-triazine, Tricyclo[5.2.1.0]decanedimethanol diacrylate, Trimethylolpropane benzoate diacrylate, Trimethylolpropane ethoxylate methyl ether diacrylate, Trimethylolpropane ethoxylate triacrylate, Trimethylolpropane triacrylate, Trimethylolpropane trimethacrylate, Tris[2-(acryloyloxy)ethyl]isocyanurate, Tri(propylene glycol) diacrylate.

Optionally, the monomer composition comprises at least one charged co-monomer.

Examples of cationic monomers for particle stability and particle size control are 2-methacryloxy ethyl trimethyl ammonium chloride (MOTAC), acryloxy ethyl trimethyl ammonium chloride (AOTAC), [3-(Methacryloylamino)propyl]trimethylammonium chloride, [2-(Methacryloyloxy)ethyl]trimethylammonium methyl sulfate solution, tetraallyl ammonium chloride, diallyl dimethyl ammonium chloride, (Vinylbenzyl)trimethylammonium chloride. Preferably 2-methacryloxy ethyl trimethyl ammonium chloride (MOTAC) and acryloxy ethyl trimethyl ammonium chloride (AOTAC) are used.

Examples of anionic monomers are sodium, potassium or triethylamine salts of methacrylic acid, Acrylic acid, 2-(Trifluoromethyl)acrylic acid, 3-(2-Furyl)acrylic acid, 3-(2-Thienyl)acrylic acid, 3-(Phenylthio)acrylic acid, Poly(acrylic acid) potassium salt, Poly(acrylic acid) sodium salt, Poly(acrylic acid), Poly(acrylic acid, sodium salt) solution, trans-3-(4-Methoxybenzoyl)acrylic acid, 2-Methoxycinnamic acid, 3-Indoleacrylic acid, 3-Methoxycinnamic acid, 4-Imidazoleacrylic acid, 4-Methoxycinnamic acid, Poly(styrene)-block-poly(acrylic acid), Poly(acrylonitrile-co-butadiene-co-acrylic acid), dicarboxy terminated, Poly(acrylonitrile-co-butadiene-co-acrylic acid), dicarboxy terminated, glycidyl methacrylate diester, 2,3-Diphenyl-Acrylic Acid, 2-Me-Acrylic Acid, 3-(1-Naphthyl)Acrylic Acid, 3-(2,3,5,6-Tetramethylbenzoyl)Acrylic Acid, 3-(4-Methoxyphenyl)Acrylic Acid, 3-(4-Pyridyl)Acrylic Acid, 3-p-Tolyl-Acrylic Acid, 5-Norbornene-2-Acrylic Acid, Trans-3-(2,5-Dimethylbenzoyl)Acrylic Acid, Trans-3-(4-Ethoxybenzoyl)Acrylic Acid, Trans-3-(4-Methoxybenzoyl)Acrylic Acid, 2,2′-(1,3-Phenylene)Bis(3-(2-aminophenyl)Acrylic Acid), 2,2′-(1,3-Phenylene)Bis(3-(2-Aminophenyl)Acrylic Acid) hydrochloride, 2,2′-(1,3-Phenylene)Bis(3-(2-Nitrophenyl)Acrylic Acid), 2-[2-(2′,4′-Difluoro[1,1′-Biphenyl]-4-Yl)-2-Oxoethyl]Acrylic Acid, 2-(2-(2-Chloroanilino)-2-Oxoethyl)-3-(4-Methoxyphenyl)Acrylic Acid, 2-(2-((2-Hydroxyethyl)Amino)-2-Oxoethyl)-3-(4-Methoxyphenyl)Acrylic Acid, 2-(2-(Cyclohexylamino)-2-Oxoethyl)-3-(4-Methoxyphenyl)Acrylic Acid.

A further co-monomer may be a polymerisable dye. In general the polymerisable dyes may be solvent soluble or water soluble and they may be anionic, cationic, zwitterionic or neutral. Polymerisable dyes consist of a chromophore, at least one polymerisable group, optional linker groups (spacers), and optional groups to modify physical properties (like). Preferred polymerisable dyes are azo dyes, metallised dyes, anthraquinone dyes, phthalocyanine dyes, benzodifuranones dyes, Brilliant Blue derivatives, pyrroline dyes, squarilium dyes, triphendioxazine dyes or mixtures of these dyes, especially azo dyes, metallised dyes, anthraquinone dyes, phthalocyanine dyes, benzodifuranones dyes, pyrroline dyes, squarilium dyes or mixtures of these dyes. Preferably dyes with more than one polymerisable group are used. In principle any polymerisable dye can be used, preferable with more than one polymerisable group (most preferably with 2 polymerisable groups) and preferably with a methacrylate or acrylate function. Advantageously, the polymerisable dyes disclosed in WO2010/089057 and WO2012/019704 are used. Preferably dyes of Formulas (I′)-(VI′) are used:

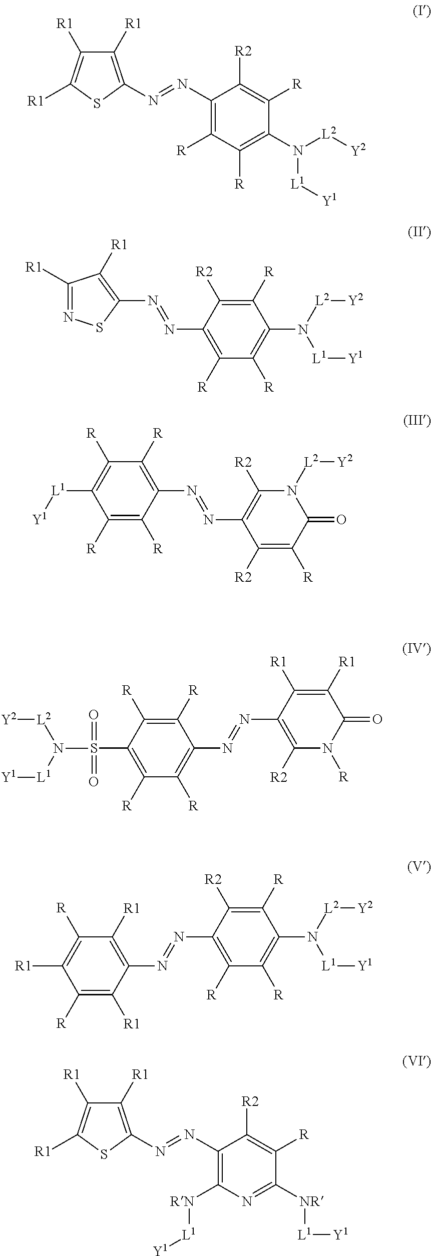

wherein R is H; R1 and R2 are independently of one another alkyl, preferably C1-C6 alkyl, —OR′, —SR′, —C(O)R′, —C(O)OR′, —NHCOR′, —NO₂, —CN, with R′ equal to H or alkyl, preferably C1-C6 alkyl, especially C1-C3 alkyl; L¹ and L² are independently of one another a single bond, C1-C6 alkyl, a polyether alkyl chain, or a combination thereof, preferably C2-C4 alkyl, especially C2 and C4 alkyl, especially identical groups L¹ and L² are preferred; and Y¹ and Y² are methyl acrylate or methyl methacrylate, especially identical groups Y¹ and Y² are preferred.

Especially preferred are polymerisable dyes of Formulas (I′)-(VI′) wherein R is H; R1 and R2 are independently of one another —CH₃, —NO₂, —OH, —CN, —COCH₃, —CO₂CH₂CH₃, —NHCOR′; L¹ and L² are, preferably identical, C2-C4 alkyl, and Y¹ and Y² are, preferably identical, methyl acrylate or methyl methacrylate, wherein R2 is preferably —CH₃, —OH or —NHCOR′.

Especially preferred co-monomers are methyl methacrylate, methyl acrylate, and methacrylic acid, acrylic acid, ethane-1,2 diacrylate, butane-1,4 diacrylate, hexane-1,6-diacrylate. Furthermore, mixtures of co-monomers described in the foregoing may be used. Preferred co-monomers mixtures comprise methyl methacrylate methyl acrylate, methacrylic acid, acrylic acid, ethane-1,2 diacrylate, butane-1,4 diacrylate, hexane-1,6-diacrylate, trimethylolpropane triacrylate, 2-methacryloxy ethyl trimethyl ammonium chloride (MOTAC) and/or acryloxy ethyl trimethyl ammonium chloride (AOTAC).

A further subject of the invention is a process for the preparation of particles comprising organic or inorganic pigment core particles coated with at least one polymerisation mediating agent encapsulated by a polymeric shell comprising monomer units of at least one polymerisable steric stabiliser, at least one co-monomer, optionally at least one charged co-monomer, optionally at least one polymerisable dye, and optionally at least one crosslinking co-monomer, wherein the polymeric shell is linked to the surface of the organic or inorganic pigment core particles by at least one reagent for controlled radical polymerisation, preferably by a RAFT agent.

The present process comprises the following steps:

a) surface functionalising an organic or inorganic pigment particle with a reagent for controlled radical polymerisation; preferably with a RAFT agent;

b) isolating the surface functionalised organic or inorganic pigment particle;

c) dispersing the isolated surface functionalised organic or inorganic pigment particle in a solution of at least one polymerisable steric stabiliser in a non-polar organic solvent;

d) adding at least one co-monomer, at least one initiator, optionally at least one polymerisable dye, and optionally at least one chain transfer agent;

e) subjecting the dispersion of step d) to heating and sonication for polymerisation;

f) optionally washing by repeated centrifugation and redispersion in fresh solvent; and

g) optionally isolating the resulting coated particles.

This process provides pigment particles, especially titania embedded in a polymeric shell by addition of a RAFT agent to the pigment particles before polymerisation.

RAFT agents are prepared by typical procedures in the literature (J. Chiefari et al, Macromolecules, 1998, 31, 5559; Moad G. et al., Polym. Int., 2000, 49, 993-1001; Zard S. Z. et al, Tet. Lett, 1999, 40, 277-280; Thang S. H. et al, Tet. Lett, 1999, 40, 2435-2438).

In a typical synthesis as outlined in Scheme 1, a phenyl magnesium bromide is added to a degassed flask and carbon disulfide is added under stirring and cooling. Once addition is complete, the reaction is allowed to proceed for a short time before being acidified to the thioacid. The iodine is then added to the thioacid to dimerise at which point the intermediate is purified. The purified dimer is then added to a solution containing an azobis cyanovaleric acid which is heated and stirred overnight to yield an acid functional RAFT agent which is then purified over silica.

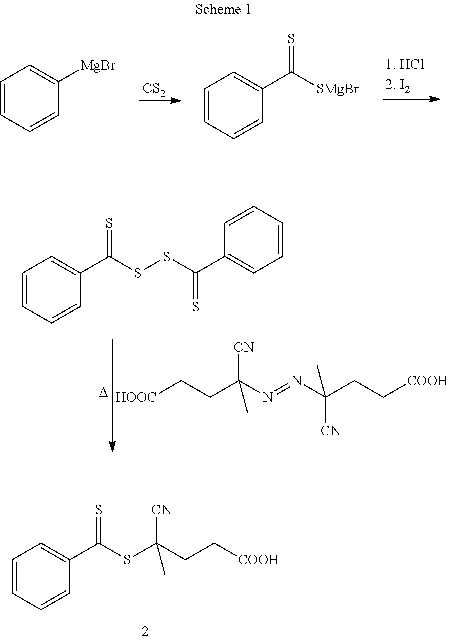

Pigment particle surface functionalisation is carried out using modified literature methods and particles are prepared by a modified dispersion polymerisation. This means that at the start of the reaction, the mixture is homogeneous, and as polymerisation proceeds, polymer forms which is insoluble and forms particles. A typical procedure is outlined below and in more detail in the experimental section. The functionalisation of the pigment particles is exemplified in the following for titania:

Titanium dioxide is dispersed in a polar, organic solvent, i.e. chloroform. To this the RAFT agent and N,N′-diethylcarbodiimide are added and cooled on ice. A solution of 4-N,N′-dimethylaminopyridine in chloroform is added and the solution is allowed to warm up to room temperature and react for 24 hours. The functionalised titanium dioxide is isolated by centrifugal separation.

Further N,N′-dialkylcarbodiimides may be N,N′-dicyclohexylcarbodiimides (DCC) or N,N′-diisopropylcarbodiimides, 1-ethyl-3-(3-dimethylaminopropyl)carbodiimide (EDAC), or polymer supported EDAC, polymer supported DCC, 1,1′-carbonyldiimidazole, 2-chloro-1,3-dimethylimidazolidinium hexafluorophosphate.

Further tertiary amines may be 4-N,N′-dimethylaminopyridine on a polymer support, dimethylaminopyridine-p-toluene sulphonic acid, triethylamine.

The preparation process of the particles of the invention is done directly in a non-polar fluid suitable for EPD formulations. No expensive drying steps are necessary. The particles can then also be easily formulated for EPD fluids by addition of any required surfactants directly into the dispersion without necessarily changing solvents. Furthermore, a polymerisable steric stabiliser which has reactivity to the polymer and is highly soluble in the non-polar fluid is used in the process for the preparation of the particles. This results in a covalently bonded layer on the outer surface of the pigment core particle which effects simple dispersion in non-polar EPD media.

The embedding of the inorganic pigment in the organic polymer is enhanced through surface modification of the polymer using agents which mediate and control the polymerisation. These agents are designed to have high reactivity to a growing polymer chain but not to stop or hinder the polymerisation in any way in order to develop a coherent polymer shell around a pigment particle. Typically RAFT and NMP agents are used and preferably dithio and trithio ester RAFT agents.

Size and polydispersity of the particles according to the invention can be controlled through control of the polymerisation and the use of ultrasound. Through correct design of the experiment and quantities of reagents used in synthesis, particles can be created which exhibit low polydispersity and controllable sizes over a wide range. The use of ultrasound in the reaction can enhance this. Typical process conditions are known to experts in the field.

The particles of the invention are preferably prepared using a dispersion polymerisation. This is a convenient single step method of preparing monodisperse coloured particles. The solvent for the dispersion can be chosen primarily on the basis of dielectric constant, refractive index, density and viscosity. A preferred solvent choice would display a low dielectric constant (<10, more preferably <5), high volume resistivity (about 10¹⁵ ohm-cm), a low viscosity (less than 5 cst), low water solubility, a high boiling point (>80° C.) and a refractive index and density similar to that of the undyed particles. Tweaking these variables can be useful in order to change the behaviour of the final application. Preferred solvents are often non-polar hydrocarbon solvents such as the Isopar series (Exxon-Mobil), Norpar, Shell-Sol (Shell), Sol-Trol (Shell), naphtha, and other petroleum solvents, decalin, tetralin as well as long chain alkanes such as dodecane, hexadecane, tetradecane, decane and nonane. These tend to be low dielectric, low viscosity, and low density solvents. A density matched particle/solvent mixture will yield much improved settling/sedimentation characteristics and thus is desirable. For this reason, often it can be useful to add a halogenated solvent to enable density matching.

Typical examples of such solvents are the Halocarbon oil series (Halocarbon products), or tetrachloroethylene, carbon tetrachloride, 1,2,4-trichlorobenzene and similar solvents. The solvent which is particularly suitable is a dodecane.

The selection of the polymerisation conditions depends on the required size and size distribution of the particles. Adjustment of polymerisation conditions is well known to someone skilled in the art.

Preferably, a batch polymerisation process is used wherein all reactants are completely added at the outset of the polymerisation process. In such process only relatively few variables have to be adjusted for a given formulation. Preferred changes which can be made in such cases are to the reaction temperature, reactor design and the type and speed of stirring.

Thus, a batch polymerisation process is used for manufacture versus a semi-continuous batch process because of limited versatility and simple evaluations of reaction formulation.

Preferably the polymerisation according to the invention is a free radical polymerisation.

Typical process conditions are described for titanium dioxide particles coated according to the invention.

RAFT functionalized titanium dioxide is added to a non-polar hydrocarbon solvents, preferably dodecane and PDMS-methacrylate. The solution is lightly sonicated to disperse the pigment. A comonomer, preferably MMA, and a chain transfer agent, preferably octanethiol are then added to the solution which is stirred under nitrogen, then heated to 60-90, preferably 85° C. in a sonic bath. Sonication is applied to the reaction and an initiator, preferably azobisisobutyronitrile is added to initiate polymerisation. The reaction is allowed to proceed for approximately 2-6, preferably 4 hours after which time the reaction is cooled and particles are cleaned if necessary by centrifugation and washing with dodecane.

Particles are often monodisperse and any particles which are free of pigment can be separated by centrifugation if required.

The concentration of the final particles in the non-polar solvent can be increased if desired by centrifugation, i.e. forced settling of the particles and pouring off excess solvent, or a stirred cell filtration system can be used. The dispersion can be washed with a non-polar solvent if required. If necessary, the particles are simply separated from the reaction suspension by filtration, preferably by pouring the suspension through a pore size filter, i.e. a 0.1 μm pore size filter, or the particles can be cleaned by centrifuging.

Usually, a polymerisation composition for the preparation of particles according to the invention comprises at least one organic or inorganic pigment particle, at least one polymerisable steric stabiliser, at least one co-monomer, at least one initiator, optionally at least one charged co-monomer, optionally at least one polymerisable dye, optionally at least one chain transfer agent, and optionally at least one crosslinking co-monomer in a non-aqueous solvent.

Advantageously, for the process of the invention a combination of the above-mentioned preferred compounds is used, i.e. preferred compounds of inorganic pigment particles, RAFT agents, polymerisable steric stabiliser, co-monomer, and cross-linking co-monomer. Most preferred are combinations of titanium dioxide in the rutile or anatase modification, 4-((thiobenzoyl)sulfanyl)-4-cyano-pentanoic acid or 3-((thiododecanoyl)sulfanyl)-3-methyl-propanoic acid as RAFT agents, methacrylate terminated polydimethylsiloxanes with a molecular weight of 10,000 or more, and methyl methacrylate.

Charging the polymer can also be facilitated by using an initiator which is charged leaving that charge residing as an end-group on the polymer. Such examples are 2,2′-azobis(2-methylpropionamidine)dihydrochloride (V-50) (Wako Chemicals), potassium peroxodisulfate (KPS), ammonium peroxodisulfate (APS), sodium peroxodisulfate (SPS), 2,2′-azobiscyanovaleric acid (ACVA) (Wako Chemicals), 2,2′-azobis[2-(2-imidazolin-2-yl)propane]dihydrochloride (VA044) (Wako Chemicals).

Charging does not have to come from the initiator fragment so initiators which can also be used are those such as 2,2′-azobis(isobutyronitrile) (AIBN) (Wako Chemicals), 2,2′-azobis(2-methylbutyronitrile) (Vazo 67) (Wako Chemicals) and benzoyl peroxide.

Optionally, the polymerisable compositions of the invention comprise a chain transfer agent, e.g. catalytic chain transfer reagents, alkyl and aryl thiols, alcohols and carboxylic acids, halogenated organics and selected inorganic salts. Examples of suitable chain transfer agents are 2-propanol, adipic acid, thioglycolic acid, 2-mercaptoethanol, sodium hypochlorite, carbon tetrachloride and heavy metal poryphyrins, particularly cobalt poryphyrins preferably octane thiol.

The polymerisable composition of the invention usually comprises 0.1-75%, preferably 20-60%, by weight of at least one RAFT functionalized organic or inorganic pigment particle, 0.1-50%, preferably 10-40%, by weight of at least one polymerisable steric stabiliser, 50-95%, preferably 60-90%, by weight of co-monomer, optionally 1-40%, preferably 1-10%, by weight of cross-linking co-monomer, optionally 1-30%, preferably 1-10%, by weight of charged co-monomer, optionally 0-3%, by weight of chain transfer agent, and 0.1-10%, preferably 0.1-7.5%, by weight of initiator, all percentages are based on the total weight of the polymerisable composition (except solvent).

Advantageously, the polymerisable composition of the invention comprises in a non-polar hydrocarbon solvent, especially dodecane, 20-60%, by weight of at least one of the above-mentioned preferred RAFT functionalized organic or inorganic pigment particles, 10-40% by weight of at least one of the above-mentioned preferred polymerisable steric stabilisers, 60-90% by weight of at least one of the above-mentioned preferred co-monomers, 0.1-7.55% by weight of initiator, optionally 1-10% by weight of cross-linking co-monomer, optionally 1-10% by weight of charged co-monomer, and optionally 0-3%, by weight of chain transfer agent, wherein most preferably titanium dioxide in the rutile or anatase modification, 4-((thiobenzoyl)sulfanyl)-4-cyano-pentanoic acid or 3-((thiododecanoyl)sulfanyl)-3-methyl-propanoic acid, methacrylate terminated polydimethylsiloxanes with a molecular weight of 10,000 or more, and methyl methacrylate are used.

All components added to the synthesis are readily available from chemical suppliers thereby allowing to tune parameters easily to get the desired properties. Properties can be selected in many cases by simply choosing from a range of commercially available components from which to synthesis the particles.

Polymer particles prepared according to the invention are preferably spherical particles with a size (diameter) in the range of 50-1200 nm, preferably 400-1000 nm, especially 400-700 nm, and preferably with a monodisperse size distribution.

Smaller or larger particles can be further separated if required by centrifugation.

Particle sizes are determined by photon correlation spectroscopy of hydrocarbon particle dispersions by a common apparatus such as a Malvern NanoZS particle analyser or preferably by SEM (Scanning Electron Microscopy) and image analysis.

Particles of the invention are primarily designed for use in electrophoretic displays, especially for use in mono, bi or polychromal electrophoretic devices. A typical electrophoretic display comprises an electrophoretic fluid comprising the particles dispersed in a low polar or non-polar solvent along with additives to improve electrophoretic properties, such as stability and charge. Examples of such electrophoretic fluids are well described in the literature, for example U.S. Pat. No. 7,247,379; WO 99/10767; US 2007/0128352; U.S. Pat. No. 7,236,290; U.S. Pat. No. 7,170,670; U.S. Pat. No. 7,038,655; U.S. Pat. No. 7,277,218; U.S. Pat. No. 7,226,550; U.S. Pat. No. 7,110,162; U.S. Pat. No. 6,956,690; U.S. Pat. No. 7,052,766; U.S. Pat. No. 6,194,488; U.S. Pat. No. 5,783,614; U.S. Pat. No. 5,403,518; U.S. Pat. No. 5,380,362.

The particles of the invention, especially the presented white reflective particles may be used in combination with a dyed fluid, additional particles such as oppositely charged black, with oppositely charged coloured particles or with equally charged coloured particles and oppositely charged black particles. The particles of the invention, especially the present white reflective particles may be used for example in combination with coloured or black polymer particles.

Preferably these additional black or coloured polymer particles comprise a polymerised or co-polymerised dye. Especially coloured copolymers particles comprising monomer units of at least one monomer, of at least one polymerisable dye, optionally of at least one charged co-monomer, and optionally of at least one crosslinking co-monomer are preferred. The polymerisable dye comprises preferably a chromophore, preferably an azo group, anthraquinone group or phthalocyanine group, one or more polymerisable groups, and optional linker groups. To enhance the surface stabilisation or steric repulsions of the coloured polymeric particles in a non-polar continuous phase, a steric stabiliser is preferably incorporated into the coloured polymer particles. Especially, the polymer particles described in WO 2009/100803, WO 2010/089057, WO 2010/089058, WO 2010/089059, WO 2010/089060, WO 2011/154103 and/or WO 2012/019704 are suitable for incorporation in the CSD polymers of the invention. Preferably, polymer particles described in WO 2010/089057 and/or WO 2012/019704 may be used.

Typical additives to improve the stability of the fluid (either by steric stabilisation or by use as a charging agent) are known to experts in the field and include (but are not limited to) the Brij, Span and Tween series of surfactants (Aldrich), Infineum surfactants (Infineum), the Solsperse, Ircosperse and Colorburst series (Lubrizol), the OLOA charging agents (Chevron Chemicals) and Aerosol-OT (Aldrich). Typical surfactants used in this process are cationic, anionic, zwitterionic or non-ionic with a hydrophilic portion usually termed the head group which is mono-, di- or polysubstituted with a hydrophobic portion usually termed the tail. The hydrophilic head group of the surfactant in this process can be, but is not limited to being, made up of derivatives of sulfonates, sulfates, carboxylates, phosphates, ammoniums, quaternary ammoniums, betaines, sulfobetaines, imides, anhydrides, polyoxyethylene (e.g. PEO/PEG/PPG), polyols (e.g. sucrose, sorbitan, glycerol etc), polypeptides and polyglycidyls. The hydrophobic tail of the surfactant in this process can be, but is not limited to being, made up of straight and branched chain alkyls, olefins and polyolefins, rosin derivatives, PPO, hydroxyl and polyhydroxystearic acid type chains, perfluoroalkyls, aryls and mixed alkyl-aryls, silicones, lignin derivatives, and partially unsaturated versions of those mentioned above. Surfactants for this process can also be catanionic, bolaforms, gemini, polymeric and polymerisable type surfactants.

Any other additives to improve the electrophoretic properties can be incorporated provided they are soluble in the formulation medium, in particular thickening agents or polymer additives designed to minimise settling effects.

The dispersion solvent can be chosen primarily on the basis of dielectric constant, refractive index, density and viscosity. A preferred solvent choice would display a low dielectric constant (<10, more preferably <5), high volume resistivity (about 10¹⁵ ohm-cm), a low viscosity (less than 5 cst), low water solubility, a high boiling point (>80° C.) and a refractive index and density similar to that of the particles. Adjustment of these variables can be useful in order to change the behavior of the final application. For example, in a slow-switching application such as poster displays or shelf labels, it can be advantageous to have an increased viscosity to improve the lifetime of the image, at the cost of slower switching speeds. However in an application requiring fast switching, for example e-books and displays, a lower viscosity will enable faster switching, at the cost of the lifetime in which the image remains stable (and hence an increase in power consumption as the display will need more frequent addressing). The preferred solvents are often non-polar hydrocarbon solvents such as the Isopar series (Exxon-Mobil), Norpar, Shell-Sol (Shell), Sol-Trol (Shell), naphtha, and other petroleum solvents, as well as long chain alkanes such as dodecane, tetradecane, decane and nonane). These tend to be low dielectric, low viscosity, and low density solvents. A density matched particle/solvent mixture will yield much improved settling/sedimentation characteristics and thus is desirable. For this reason, often it can be useful to add a halogenated solvent to enable density matching. Typical examples of such solvents are the Halocarbon oil series (Halocarbon products), or tetrachloroethylene, carbon tetrachloride, 1,2,4-trichlorobenzene and similar solvents. The negative aspect of many of these solvents is toxicity and environmental friendliness, and so in some cases it can also be beneficial to add additives to enhance stability to sedimentation rather than using such solvents.

The preferred additives and solvents used in the formulation of the particles of the invention are Aerosol OT (Aldrich), Span 85 (Aldrich), and dodecane (Sigma Aldrich).

The solvents and additives used to disperse the particles are not limited to those used within the examples of this invention and many other solvents and/or dispersants can be used. Lists of suitable solvents and dispersants for electrophoretic displays can be found in existing literature, in particular WO 99/10767 and WO 2005/017046. The Electrophoretic fluid is then incorporated into an Electrophoretic display element by a variety of pixel architectures, such as can be found in C. M. Lampert, Displays; 2004, 25(5) published by Elsevier B.V., Amsterdam,

The Electrophoretic fluid may be applied by several techniques such as inkjet printing, slot die spraying, nozzle spraying, and flexographic printing, or any other contact or contactless printing or deposition technique.

Electrophoretic displays comprise typically, the electrophoretic display media in close combination with a monolithic or patterned backplane electrode structure, suitable for switching the pixels or patterned elements between the black and white optical states or their intermediate greyscale states.

The coloured and white reflective polymer particles according to the present invention are suitable for all known electrophoretic media and electrophoretic displays, e.g. flexible displays, TIR-EPD (total internal reflection electrophoretic devices), one particle systems, two particle systems, dyed fluids, systems comprising microcapsules, microcup systems, air gap systems and others as described in C. M. Lampert, Displays; 2004, 25(5) published by Elsevier B.V., Amsterdam. Examples of flexible displays are dynamic keypads, e-paper watches, dynamic pricing and advertising, e-readers, rollable displays, smart card media, product packaging, mobile phones, lab tops, display card, digital signage.

Particles of the invention may also be used in optical, electrooptical, electronic, electrochemical, electrophotographic, electrowetting displays and/or devices, e.g. TIR (total internal reflection electronic devices), and in security, cosmetic, decorative, and diagnostic applications. The use in electrowetting displays is preferred. Electrowetting (ew) is a physical process where the wetting properties of a liquid droplet are modified by the presence of an electric field. This effect can be used to manipulate the position of a coloured fluid within a pixel. For example, a nonpolar (hydrophobic) solvent containing colourant can be mixed with a clear colourless polar solvent (hydrophilic), and when the resultant biphasic mixture is placed on a suitable electrowetting surface, for example a highly hydrophobic dielectric layer, an optical effect can be achieved. When the sample is at rest, the coloured non-polar phase will wet the hydrophobic surface, and spread across the pixel. To the observer, the pixel would appear coloured. When a voltage is applied, the hydrophobicity of the surface alters, and the surface interactions between the polar phase and the dielectric layer are no longer unfavourable. The polar phase wets the surface, and the coloured non-polar phase is thus driven to a contracted state, for example in one corner of the pixel. To the observer, the pixel would now appear transparent. A typical electrowetting display device consists of the particles in a low polar or non-polar solvent along with additives to improve properties, such as stability and charge. Examples of such electrowetting fluids are described in the literature, for example in WO2011/017446, WO 2010/104606, and WO2011075720.

The disclosures in the cited references are expressly also part of the disclosure content of the present patent application. In the claims and the description, the words “comprise/comprises/comprising” and “contain/contains/containing” mean that the listed components are included but that other components are not excluded. The following examples explain the present invention in greater detail without restricting the scope of protection.

### EXAMPLES

All materials and solvents used are sourced from Sigma-Aldrich and used without further purification unless otherwise stated. TiPure R960 titanium dioxide is sourced from Du Pont and is used as supplied, TiOxide TR-92 is obtained from Huntsman and is used as supplied, Hombitan Anatase is supplied by Sachtleben and is used as supplied. Polydimethylsiloxane-methacrylate (PDMS-MA) with a molecular weight of 10,000 is obtained from Gelest and used without further purification.

Particle size is measured by SEM.

The characterisation of the formulations is performed using a Malvern NanoZS particle analyser. This instrument measures the size of particles in dispersion and the zeta potential of an electrophoretic fluid. The Zeta potential (ZP) is derived from the real-time measurement of the electrophoretic mobility and thus is an indicator of the suitability of the fluid for use in electrophoretic applications.

### Example 1

### Dithiobenzoate Synthesis

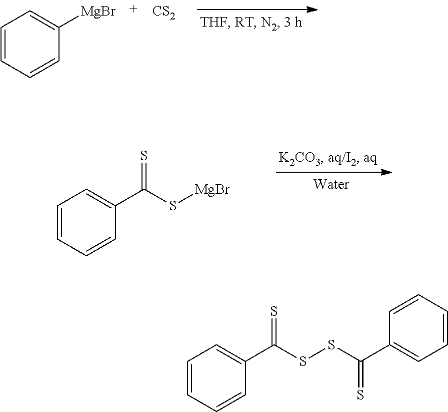

### Stage 1. Disulfide Compound

1M Phenyl magnesium bromide solution in tetrahydrofuran (THF) (50 ml, 0.05 mol) is stirred and carbon disulfide (3.3 ml, 0.055 mol) is added dropwise. The reaction mixture is stirred under N₂ for 2-3 hours. After THF extraction under vacuum, a solution of potassium carbonate is introduced. Purple crystals of disulfide are formed by addition of a 0.96 mol aqueous solution of iodine (52 ml, 0.05 mol). The final dithiobenzoyl disulfide is obtained by several extractions in dichloromethane and solvent evaporation under vacuum.

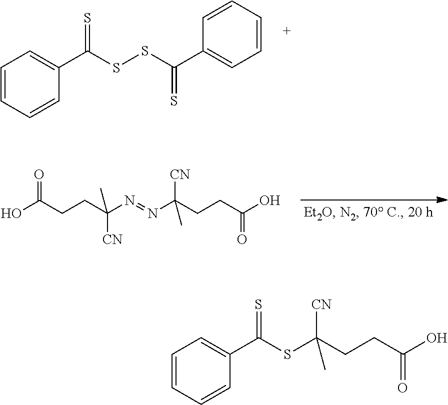 [SMILES: S=C(SSC(=S)c1ccccc1)c1ccccc1 ; CC(C#N)(CCC(=O)O)/N=N/C(C)(C#N)CCC(=O)O ; CC(C#N)(CCC(=O)O)SC(=S)c1ccccc1]

### Stage 2. Dithiobenzoate

Dithiobenzoyl disulfide (4.00 g, 0.0131 mol) is stirred in a solution of ethyl acetate (30 ml); 4,4′-azobis(4-cyanopropanol (3.60 g, 0.014 mol) is added. After 3 freeze-pump-thaw cycles, the reaction mixture is heated at 70° C. for 20 h. After evaporation of the solvent under reduced pressure, the crude dithiobenzoate is passed through an alumina column (eluant: hexane/ethyl acetate). The final compound is obtained as a purple/red viscous liquid. Yield: 40%

¹H NMR (CDCl₃): 1.96 (3H, s), 2.40-2.85 (4H, m), 7.40-7.45 (2H, m), 7.55-7.65 (1H, m), 7.85-7.95 (2H, m).

### Example 2

### Trithiocarbonate Synthesis

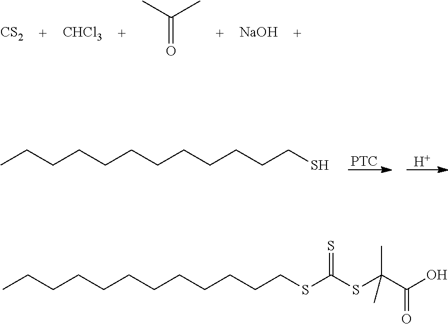

1-Dodecanethiol (47.8 ml, 0.2 mol) and Aliquot 336 (3.24 g, 0.008 mol) are stirred in acetone (250 ml) under nitrogen and at low temperature (between 0 and 10° C.). A concentrated aqueous solution of sodium hydroxide (50 wt %) (17.0 g, 0.21 mol) is slowly added dropwise and stirred for an additional 30 minutes after complete addition. Carbon disulfide (12 ml, 0.2 mol) as a solution in acetone (50 ml) is then added dropwise. Chloroform (25 ml) and a concentrated aqueous solution of sodium hydroxide (50 wt %) (80 g, 1 mol) are successively added and the stirred for 12 hours. Deionised water (300 ml) and 37% HCl (50 ml) are then added. The acetone is then removed and the solid is filtered. The solid is dissolved in 500 mL of isopropanol and filtered again. After solvent removal, the product is purified by recrystallisation in hexane. The pure product is obtained as a bright crystalline yellow powder. Yield: 64%.

¹H NMR (CDCl₃): 13.02 (1H, s), 3.40 (2H, t), 1.75 (6H, s), 1.35-1.42 (20H, m), 0.98 (3H, t).

### Example 3

### Titania Modification with Dithiobenzoate

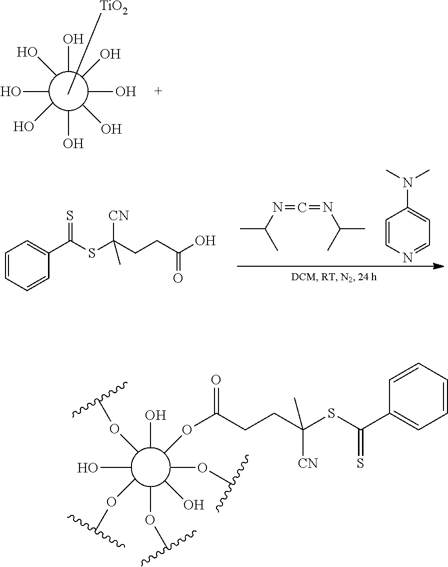

Titanium dioxide (3.50 g, 0.044 mol) is stirred under nitrogen in dichloromethane (40 ml) in the presence of “example 2” dithiobenzoate RAFT agent (257.2 mg, 0.92 mmol) and N,N′-diisopropylcarbodiimide (76.9 mg, 0.61 mmol). 4-Dimethylaminopyridine (24 mg, 0.20 mmol) is then added dropwise at 0° C. After complete addition, the reaction mixture is stirred at room temperature for 24 hours. After reaction, the surface modified TiO₂ particles are purified by repeated sedimentation/redispersion cycles. Finally, the pink powder is obtained by drying at 40° C. under reduced pressure. Yield: 65%.

### Example 4

### Titania Modification with Trithiocarbonate

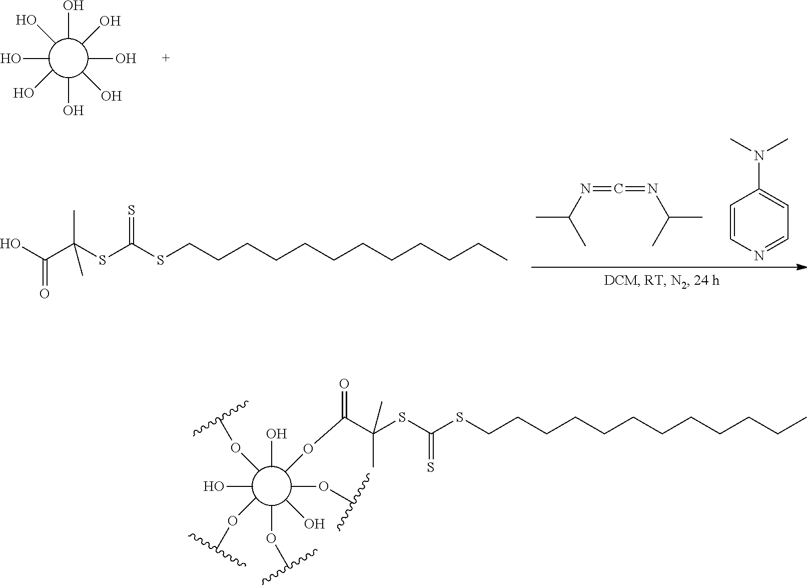

Titanium dioxide (3.50 g, 0.044 mol) is stirred under nitrogen in dichloromethane (40 ml) in the presence of “example 3” trithiocarbonate RAFT agent (336.0 mg, 0.92 mmol) agent and N,N′-diisopropylcarbodiimide (76.9 mg, 0.61 mmol). 4-dimethylaminopyridine (24 mg, 0.20 mmol) is then added dropwise at 0° C. After complete addition, the reaction mixture is stirred at room temperature for 24 hours. After reaction, the surface modified TiO₂ particles are purified by repeated centrifugation. The product is obtained as a yellow powder after drying at 40° C. under reduced pressure. Yield: 70%.

### Example 5

### Dithiobenzoate Modified TiO₂ Particles Incorporation in PMMA Latex Particles

2.25 g of “example 3” dithiobenzoate modified TiO₂ is added to a solution of PDMS-MA (mw 10,000) (1.3 g, 1.3 mmol) solubilised in dodecane (62.5 ml). After 30 minutes under ultrasound using a Fisherbrand P30 H ultrasonic bath at 120% power and 37 Hz, methyl methacrylate monomer (6.88 ml, 0.064 mol), AIBN (66.9 mg, 0.41 mmol) and octanethiol chain transfer agent (78.6 μL, 0.45 mmol)) are added. A centrifugal shaft stirrer is then fitted to the 3-necked round bottom flask and the reaction mixture is placed in an ice bath, Nitrogen bubbling is then applied for 30 minutes. The round bottomed flask is finally placed in the ultrasonic bath at 80° C., 120% power and 37 Hz, and the reaction is carried out for 4 hours at 80° C. under mechanical stirring (300 rpm), nitrogen and ultrasound (120% power).

The particles are cleaned by centrifugation. Centrifugations are carried out at 10,000 rpm for 10 minutes, replacing the supernatant with dodecane. Centrifugation/redispersion is repeated 3 times. Average particle size obtained by SEM: 520 nm.

### Example 6

### Trithiocarbonate Modified TiO₂ Particles Incorporation in PMMA Latex Particles

2.25 g of “example 4” trithiocarbonate modified TiO₂ is added to a solution of PDMS-MA (mw 10,000) (1.3 g, 1.3 mmol) solubilised in dodecane (62.5 ml). After 30 minutes under ultrasound using a Fisherbrand P30 H ultrasonic bath at 120% power and 37 Hz, methyl methacrylate monomer (6.88 ml, 0.064 mol), AIBN (66.9 mg, 0.41 mmol) and octanethiol chain transfer agent (78.6 μL, 0.45 mmol)) are added. A centrifugal shaft stirrer is then fitted to the 3-necked round bottom flask and the reaction mixture is placed in an ice bath. Nitrogen bubbling is then applied for 30 minutes. The round bottomed flask is finally placed in the ultrasonic bath at 80° C., 120% power and 37 Hz, and the reaction is carried out for 4 hours at 80° C. and mechanical stirring (300 rpm), nitrogen and ultrasound (120% power).

The particles are cleaned by centrifugation. Centrifugations are carried out at 10,000 rpm for 10 minutes, replacing the supernatant with dodecane. Centrifugation/redispersion is repeated 3 times. Average particle size obtained by SEM: 680 nm.

### Example 7

### Formulation Example of Example 6

0.0601 g of particles of Example 6 is combined with 0.0600 g Aerosol OT and 1.8812 g dodecane. The solution is mixed for 30 minutes on a roller mixer and diluted in dodecane. The zetapotential of this particle is determined to be 62.7 mV.

### Example 8

### Formulation Example of Example 5

0.0597 g of particles of Example 5 is combined with 0.0600 g Aerosol OT and 1.8775 g dodecane. The solution is mixed for 30 minutes on a roller mixer and diluted in dodecane. The zetapotential of this particle is determined to be −40.4 mV.

1.-15. (canceled)

16. Particles comprising an organic or inorganic pigment core particle encapsulated by a polymeric shell comprising monomer units of at least one polymerisable steric stabiliser, at least one co-monomer, optionally at least one charged co-monomer, optionally at least one polymerisable dye, and optionally at least one crosslinking co-monomer, wherein the polymeric shell is linked to the surface of the organic or inorganic pigment core particles by at least one reagent for controlled radical polymerisation.

17. The particles according to claim 16, wherein the pigment core particle is titanium dioxide in the rutile, anatase, or amorphous modification or carbon black.

18. The particles according to claim 16, wherein the reagent for controlled radical polymerisation is a reversible addition fragmentation transfer (RAFT) agent.

19. The particles according to claim 16, wherein the polymerisable steric stabiliser is a poly(dimethylsiloxane) macromonomer with at least one polymerisable group and a molecular weight in the range of 1000-50000.

20. The particles according to claim 16, wherein the polymerisable steric stabiliser is a mono-methacrylate terminated poly-dimethylsiloxanes.

21. The particles according to claim 16, wherein the percentage of polymerisable steric stabiliser is at least 5% by weight based on the weight of the particle.

22. The particles according to claim 16, wherein the particles have a diameter of 400-1000 nm.

23. A process for the preparation of particles according claim 16 comprising
a) surface functionalising an organic or inorganic pigment particle with a reagent for controlled radical polymerisation;
b) isolating the surface functionalised organic or inorganic pigment particle;
c) dispersing the isolated surface functionalised organic or inorganic pigment particle in a solution of at least one polymerisable steric stabiliser in a non-polar organic solvent;
d) adding at least on co-monomer, at least one initiator, optionally at least one polymerisable dye, and optionally at least one chain transfer agent;
e) subjecting the dispersion of step d) to heating and sonication for polymerisation;
f) optionally washing by repeated centrifugation and redispersion in fresh solvent; and
g) optionally isolating the resulting coated particles.

24. The process according to claim 23, wherein in step a) a RAFT agent is used as a reagent for controlled radical polymerization.

25. A method comprising utilizing the particles according to claim 16 in optical, electrooptical, electronic, electrochemical, electrophotographic, electrowetting and electrophoretic displays and/or devices, and in security, cosmetic, decorative, and diagnostic applications.

26. A method comprising utilizing the particles prepared by the process according to claim 23 in optical, electrooptical, electronic, electrochemical, electrophotographic, electrowetting and electrophoretic displays and/or devices, and in security, cosmetic, decorative, and diagnostic applications.

27. An electrophoretic fluid comprising particles according to claim 16.

28. An electrophoretic fluid comprising particles prepared by a process according to claim 23.

29. An electrophoretic display device comprising an electrophoretic fluid according to claim 27.

30. The electrophoretic display device according to claim 29, wherein the electrophoretic fluid is applied by a technique selected from inkjet printing, slot die spraying, nozzle spraying, and flexographic printing, or any other contact or contactless printing or deposition technique.
